(19) United States
(12) Patent Application Publication
(10) Pub. No.: US 2002/0047768 A1
(43) Pub. Date: Apr. 25, 2002

(54) Microelectronic magnetic structure, device including the structure, and methods of forming the structure and device

(76) Inventor: Thomas P. Duffy, Chandler, AZ (US)

Correspondence Address: SNELL & WILMER, ONE ARIZONA CENTER, 400 EAST VAN BUREN, PHOENIX, AZ, 850040001

(21) Appl. No.: 09/975,026

(22) Filed: Oct. 10, 2001

Related U.S. Application Data
(60) Provisional application No. 60/238,994, filed on Oct. 10, 2000.

(51) Int. Cl. H01F 21/02; H01F 27/28; H01F 27/24

(52) U.S. Cl. 336/145; 336/182; 336/219; 29/602.1; 29/607; 29/852

(57) ABSTRACT

An improved magnetic structure suitable for electronic applications is disclosed. The magnetic structure may be formed on or within a substrate such as a printed circuit board by forming a layer of magnetic material, pattering the layer of magnetic material, and etching the layer to form the magnetic structure. Various insulating layers and/or conductive layers may then be formed over the magnetic structures as part of the substrate. Inductors suitable for use in power supplies may be formed using the magnetic structures of the present invention.

### CROSS REFERENCE TO RELATED APPLICATIONS

This Application claims priority to Provisional Application Serial No. 60/238,994, entitled Imbedded Magnetic Array, filed Oct. 10, 2000.

### FIELD OF THE INVENTION

The present invention generally relates to magnetic structures suitable for electronic components. More particularly, the invention relates to magnetic structures that may be formed within a substrate and to methods of forming the structures.

### BACKGROUND OF THE INVENTION

Magnetic structures are used to form a variety of electronic components such as transformers, inductors, and the like. The magnetic structures may be coupled to or integrated with other electronic components to form electronic devices such as switching power regulators or other integrated circuits.

Often, magnetic structures used to form electronic devices are available as discrete parts and are integrated with other electronic components by attaching the discrete magnetic component to a printed circuit board and integrating the magnetic component with other components using conductive traces formed on or within the printed circuit board. For example, high current output power supplies (e.g., suitable for supplying power to a microprocessor) such as switching regulators typically include a magnetic inductor attached to a printed circuit board and coupled to other components such as capacitors, diodes, and transistors, which are also coupled to the circuit board.

Now-known discrete magnetic components and methods of forming electronic devices using now-known magnetic components may be deficient for several reasons. First, the components are typically available only in certain sizes, and thus a device including the magnetic component must be designed using only the available magnetic components-rather than designing the magnetic component to obtain the desired characteristics of the electronic device. Second, discrete magnetic components, which are mounted on a surface of a printed circuit board, often require the largest clearance of all the electronic components that comprise the regulator. In addition, because of the relatively large size, the discrete magnetic components must often be placed relatively far from other components, such as switches, within a power regulator. Placing the magnetic component of a power regulator away from the switches of the regulator is problematic because it requires a signal transmitted through the power regulator to travel additional distance, which in turn may create parasitic resistance and/or inductance within the regulator. Moreover, in the case of multi-phase regulators, which include multiple inductors, attaching a plurality of magnetic structures may be problematic, cumbersome, and relatively expensive. Accordingly, improved magnetic components, which may readily be configured for a desired application, which occupy relatively little space, and which are relatively easy to handle, are desired.

### SUMMARY OF THE INVENTION

The present invention provides improved magnetic structures suitable for forming electronic devices, devices including the structures, and methods of forming the devices and magnetic structures. More particularly, the invention relates to magnetic structures that may be formed on or embedded in a substrate such as a printed circuit board and devices including the structures.

The way in which the present invention addresses various drawbacks of the now-known discrete magnetic structures is discussed in greater detail below. However, in general, the improved magnetic structures in accordance with the present invention may be configured for a desired application, occupy relatively little space on a substrate, and are relatively easy to form on or within a substrate.

In accordance with one embodiment of the present invention, magnetic structures are formed on or within a substrate by forming a layer of magnetic material on or within the substrate, patterning the layer of magnetic material, and etching or machining the material to form the desired structure(s). In accordance with one aspect of this embodiment, multiple layers of magnetic material may be patterned and etched or machined to form the magnetic structure. In accordance with an alternate aspect of this embodiment, a layer of pre-formed magnetic structures may be attached to a portion of the substrate.

In accordance with a further embodiment of the present invention, an inductor, including a magnetic structure, may be formed on or within a substrate by forming a layer or layers of magnetic material on or within the substrate, and patterning and etching or machining the magnetic material to form a magnetic core. In accordance with one aspect of this embodiment, the conductive winding about the magnetic core is formed by forming conductive plugs or vias coated with conductive material and traces on and within the substrate.

### BRIEF DESCRIPTION OF THE DRAWINGS

A more complete understanding of the present invention may be derived by referring to the detailed description and claims, considered in connection with the figures, wherein like reference numbers refer to similar elements throughout the figures, and:

FIG. 1 schematically illustrates a switching power regulator in accordance with the present invention;

FIG. 2a illustrates a top view of a structure including embedded magnetic structures in accordance with the present invention;

FIG. 2b illustrates, in cross section, the structure of FIG. 2a;

FIG. 3 illustrates, in cross section, a portion of a power regulator including magnetic structures in accordance with the present invention;

FIG. 4 illustrates a top cut-away view of inductors formed on a substrate in accordance with the present invention;

FIG. 5 illustrates a magnetic structure and an inductor in accordance with another embodiment of the invention;

FIG. 6 illustrates magnetic structures formed on a sacrificial substrate in accordance with the present invention; and

FIG. 7 illustrates a power regulator including magnetic structures in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EXEMPLARY EMBODIMENTS

The present invention generally relates to magnetic structures suitable for use in connection with electronic devices. More particularly, the invention relates to magnetic structures that may be formed on or within a substrate, devices including the structures, and methods of forming the magnetic structures.

The invention is conveniently described below in connection magnetic structures suitable for use in power regulators configured to supply power to microelectronic devices such as microprocessors. However, the present invention may be used in connection with other electronic devices such as transformers and the like.

The present invention may be described herein in terms of various functional components and various processing steps. It should be appreciated that such functional components may be realized by any number of hardware or structural components configured to perform the specified functions. For example, the present invention may employ various integrated components comprised of various electrical devices, e.g., resistors, transistors, capacitors, diodes and the like, whose values may be suitably configured for various intended purposes. In addition, the present invention may be practiced in any integrated circuit applications employing magnetic structures. Such general applications that may be appreciated by those skilled in the art in light of the present disclosure are not described in detail. Further, it should be noted that while various components may be suitably coupled or connected to other components within exemplary circuits, such connections and couplings can be realized by direct connection between components, or by connection through other components and devices located therebetween.

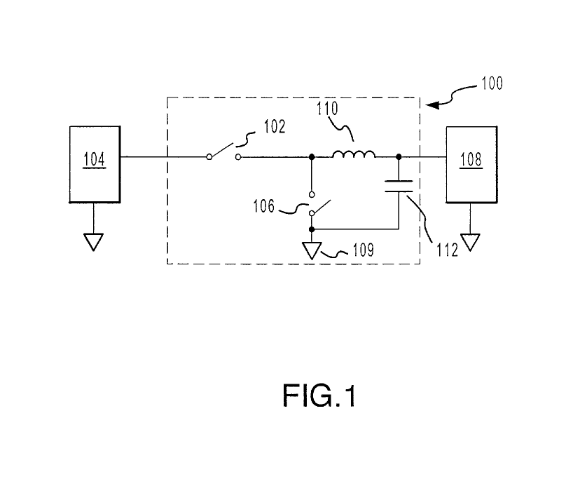

FIG. 1 schematically illustrates a switching regulator 100, including a first switch 102 coupled to a voltage source 104, a second switch 106 coupled to a load 108 (e.g., a microprocessor) and to ground 109, an inductor 110, and a capacitor 112. Regulator 100 operates by alternately coupling source 104 and ground 109 to load 108. In particular, when switch 102 is closed, inductor 110 is coupled to source 104 and charges in a linear manner and energy is stored within a magnetic core of the inductor. The voltage at load 108 is held relatively constant by capacitor 112. When switch 102 opens and switch 106 closes, the energy stored in inductor 110 begins to fall until switch 102 again closes.

Prior-art switching regulator topologies such as “Buck,” “Boost,” “Buck-Boost,” “Flyback,” etc., employ discrete components for inductor 110 and capacitor 112, which must be attached or coupled to a circuit that includes switches 102 and 106. More particularly, the inductors of prior-art regulators typically include a discrete magnetic core with copper wire wound about the core. As described in more detail below, the magnetic structures of the present invention, which are suitable for forming inductor 110, may be formed as part of a substrate and thus integrated with a circuit including switches 102 and 106.

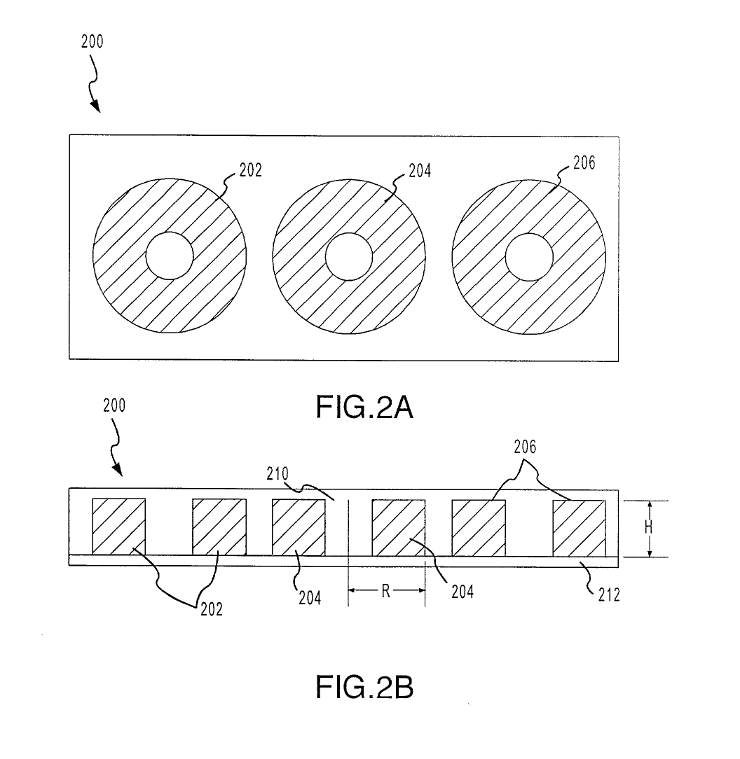

FIGS. 2a and 2b illustrate a substrate 200 including embedded magnetic structures 202, 204 and 206 in accordance with an exemplary embodiment of the present invention. Substrate 200 also includes insulating material 210 and a base 212. As explained in greater detail below, various electronic components may be attached to substrate 200 and electrically coupled to structures 202-206 to form power regulators (e.g., regulator 100, illustrate in FIG. 1) or other devices. Although illustrated with one layer of insulating material, one base, and one layer of magnetic structures, devices and structures in accordance with various embodiments of the invention may include multiple layers of insulating material, magnetic structures, and base materials.

Magnetic structures 202-206 are formed of magnetic material such as ferromagnetic or ferrite material (e.g., MMP or powdered iron). In accordance with one embodiment of the invention, structures 202-206 are formed of ferrite material manufactured by Philips Inc.

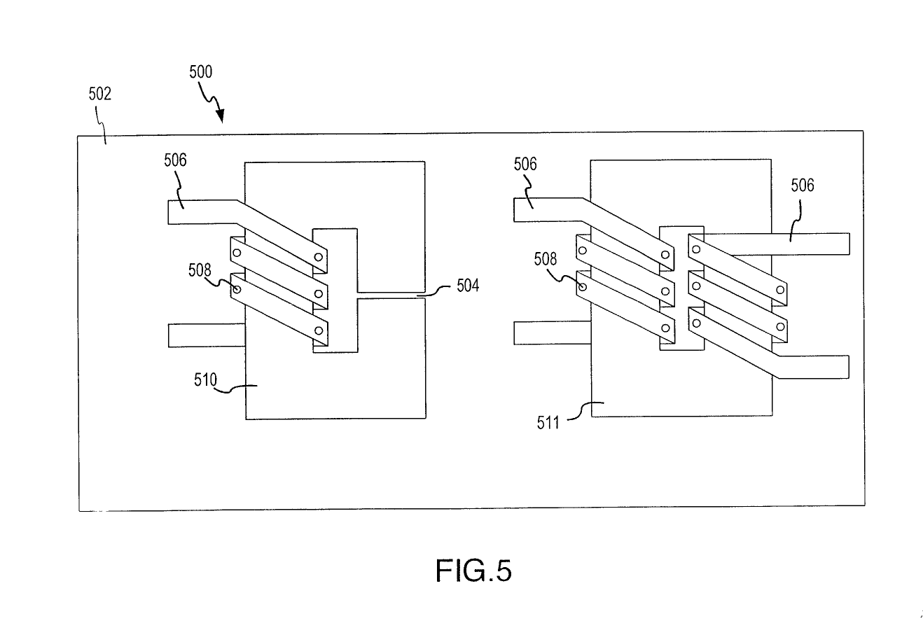

Magnetic structures 202-206 may be formed in a variety of shapes and sizes. For example, structures 202-206 may be formed as a toroid, as illustrated in FIGS. 2a and 2b, a cylinder, or in any other suitable shape. Further, as illustrated in FIG. 5, a magnetic structure may include one or more gaps formed within a portion of the structure to tailor the effective permeability of the magnetic structure.

A size of a magnetic structure in accordance with the present invention (e.g., structure 202) may vary in accordance with various applications and both a shape and size of structure 202 may be easily configured in accordance with the present invention. For example, if structure 202 forms part of an inductor, a size and/or shape of structure 202 may be configured to obtain a desired inductance for a given number of turns of conductive wire. In accordance with one exemplary embodiment of the invention, structure 202 is toroid shaped: R is about 3.15 mm and H is about 2.5 mm.

Insulating material 210 is configured to mitigate unwanted electronic signal propagation and may include any insulating or dielectric compound. To mitigate undesired degradation of material 210, structures 202-206, and/or base 212 material may desirably be selected such that the thermal coefficient of expansion of material 212 is relatively close to (e.g., within about 10% of) the thermal coefficient of expansion for material comprising magnetic structures 202-206 and base 212. In accordance with one aspect of the present embodiment, insulating material 210 includes epoxy material commonly used in the manufacture of printed circuit boards.

Base 212 may include any desired material having any desired flexibility. For example, base 212 may be formed of a flexible circuit substrate, printed circuit board material such as fire retardant epoxy laminate or polyimid material, or ceramic material as is commonly used in integrated circuit packaging. In accordance with one embodiment of the present invention, base 212 includes prepeg material suitable for forming printed circuit boards.

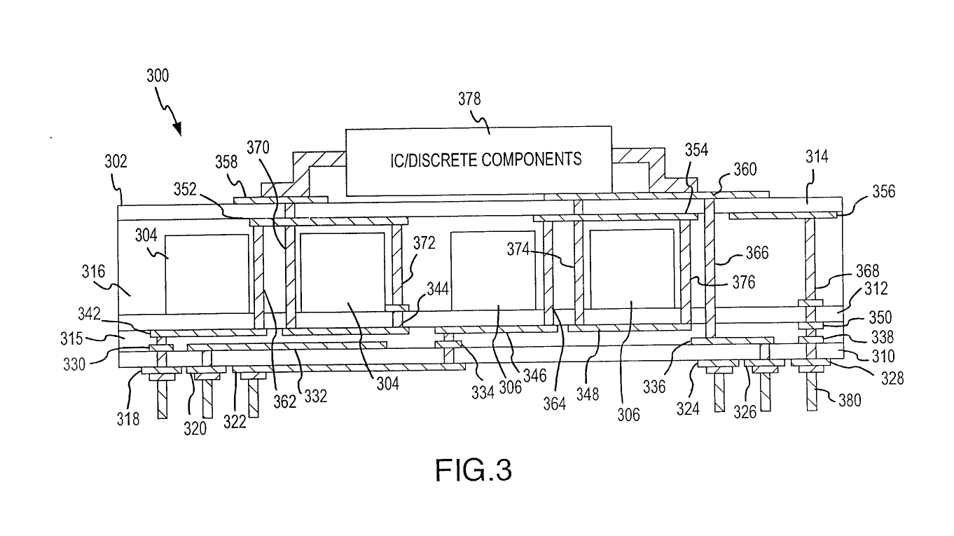

FIG. 3 illustrates a cross-sectional view of a power regulator 300 in accordance with an exemplary embodiment of the invention, having a substrate 302, which includes embedded magnetic features 304, 306. A circuit 378 comprising switches, and optionally diodes and transistors, is suitably coupled to substrate 302 to form the power regulator—e.g., the combination of device 378 and substrate 302 forms the circuit illustrated in FIG. 1.

In the illustrated embodiment, substrate 302 includes three layers 310, 312, and 314 of printed circuit board laminate dielectric material such as fire retardant epoxy laminate with glass fibers (FR4 or FR5), isolated from one another with insulating layers 315 and 316. As noted above, substrates in accordance with alternative embodiments of the present invention may include other materials such as plastics, flexible circuit material, ceramic material, or the like, and insulating layer may include any suitable electrically and magnetically non-conductive material.

Substrate 302 also includes electrical traces 318-328 formed on a lower surface of the substrate, traces 330-338, 342-350, and 352-356 formed on an interior portion of the substrate, and traces 358-360 formed on an upper surface of the substrate. Traces 318-338 and 358-360, together with conductive segments 362-368 (e.g., plugs or coated vias), are used to interconnect various components attached to substrate 302, provide a conductive path between a circuit 378 and another substrate, and, as explained in more detail below, traces 344, 348, 352, and 354 are used, together with conductive segments 370-376 to form conductive windings about magnetic structures 304 and 306. Input and output power is delivered through pins 380.

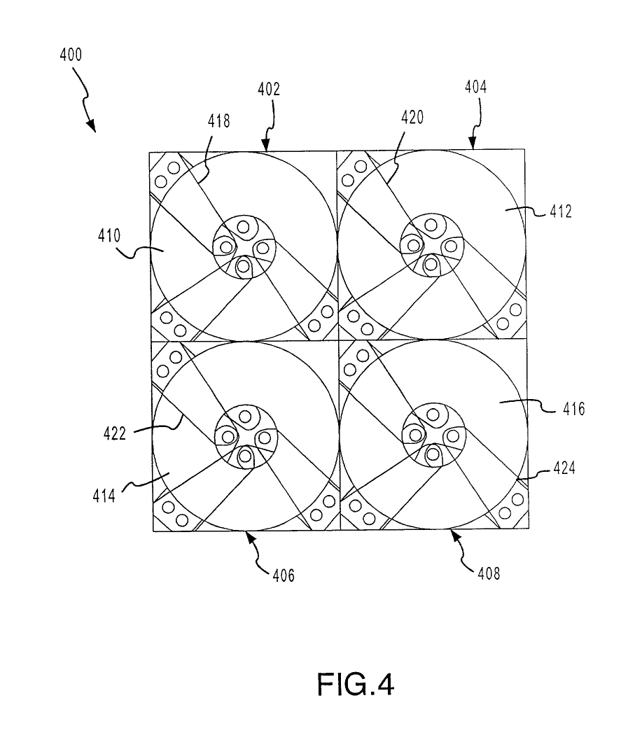

FIG. 4 illustrates a structure 400, including inductors 402-408, each respectively including a magnetic core 410-416, and conductive windings 418-442. Inductors 402-408 may be used to form power supplies such as supplies 100 and 300 illustrated above.

Forming inductors such as inductors 402-408 within a substrate is advantageous because the inductors do not occupy any volume on a surface of substrate 400 and thus the overall height of a regulator or other device including the inductors may be reduced. Moreover, because the inductors are not formed on the surface of the substrate, more integration (e.g., more inductors) per surface area of the substrate may be formed, compared to traditional power supplies. Thus, the embedded magnetic structures of the present invention may be particularly desirable for use in multi-phase power regulators. Further, as discussed in greater detail below, magnetic cores 410-416 of inductors 402-408 may be formed to a desired configuration, allowing custom configuration of inductors 402-408 and power regulators.

FIG. 5 illustrates a top cut-away view of a magnetic structure 500 formed on a surface of a substrate 502 in accordance with an alternate embodiment of the invention. Structure 500 is similar to structure 202-206, except for the shape and the addition of a gap 504 to structure 500. Structure 500 may be used to form inductors, using printed circuit windings 506, and magnetically conductive cores 510, 511 as discussed above using via connections 508. Gap 504 of structure 500 may be formed by patterning and etching magnetic core material, and the gap may be formed during the same processing used to form structure 500. FIG. 5 illustrates a two winding transformer formed in the same manner described above.

Magnetic structures of the present invention may be formed on or within a substrate such as a printed circuit board substrate using a variety of methods. In accordance with one embodiment of the invention, the structures are formed by laminating a layer of ferrite material onto a layer of a printed circuit board, patterning the ferrite material with a suitable etch-resistant mask such as photoresist or a hard mask, and etching the ferrite material to form a desired configuration of the structure. Insulating material and/or additional circuit board layers may then be laminated over the structure if desired. In accordance with one aspect of this embodiment, the structures may be formed of a plurality of layers of magnetic material, wherein each layer is patterned and etched to form a desired pattern of magnetic material. Magnetic structures formed in this manner may then be used to fabricate inductors by forming vias within the substrate, coating or filling the vias with conductive material, and forming conductive traces, which couple to the conductive material within the vias, to form conductive windings about a perimeter of the magnetic structure.

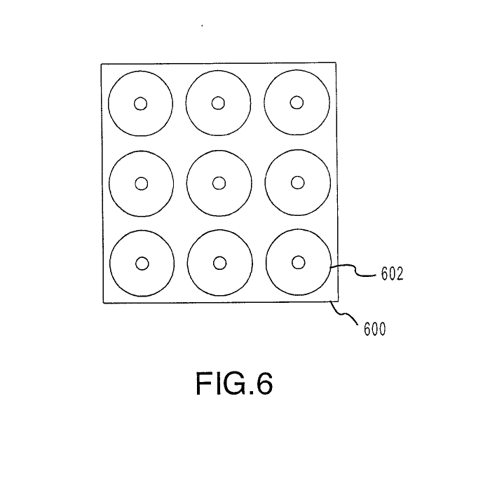

In accordance with another embodiment of the invention, magnetic structures 602 are formed on a sacrificial substrate 600, as illustrated in FIG. 6. In this case, structures 602 may be formed using the methods described above, namely patterning and etching ferrite material to form structures 602. Structures 602 may then be attached to a base such as base 212 by fixedly mounting structures 602 to base 212 and subsequently removing sacrificial substrate 600 material. If desired, substrate 600 may include registers to facilitate alignment of structures 602 to areas on base 212. Once structures 602 are attached to base 212, insulating material such as epoxy resin or the like may be applied to a top surface of structures 602 and base 212 to form the structure illustrated in FIGS. 2a and 2b.

In accordance with yet another embodiment of the invention, magnetic structures of the present invention may be formed using thick-film screen techniques, and if desired, using lasers to trim the structure to form gaps (as illustrated in FIG. 5).

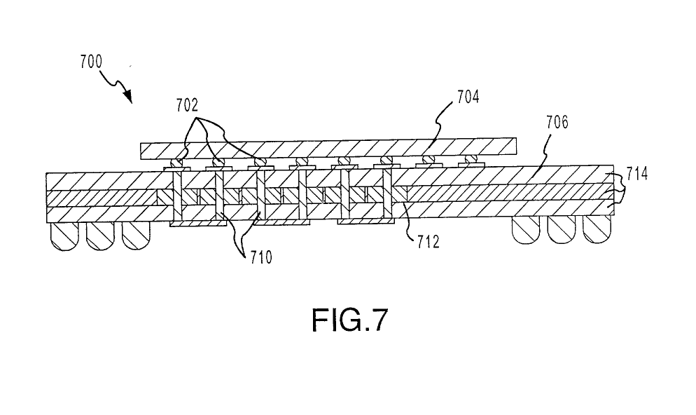

FIG. 7 illustrates a power regulator 700 in accordance with yet another embodiment of the invention. Regulator 700 is similar to the regulator illustrated in FIG. 3, except that regulator 700 employs conductive bumps 702 to couple a power integrated circuit 704 to a substrate 706. Similar to substrate 302, substrate 706 includes conductive vias 710, magnetic structures 712, and insulating material layers 714. Using conductive bumps to couple circuit 704 to substrate 706 is advantageous, because it reduces a conductive path between inductors formed within substrate 706 and the integrated circuit.

While the present invention is set forth herein in the context of the appended drawing figures, it should be appreciated that the invention is not limited to the specific form shown. For example, although the magnetic structures of the present invention are conveniently described as formed over printed circuit board substrates, other substrates may be used to form the structures and devices of the present invention. Various other modifications, variations, and enhancements in the design and arrangement of the method and apparatus set forth herein, may be made without departing from the spirit and scope of the present invention.

We claim:

1. A magnetic inductor comprising:
a non-magnetic substrate;
a magnetic core formed overlying the substrate;
insulating material formed overlying the magnetic core; and
a conductive winding formed about the core, wherein the winding comprises a conductive trace formed about an exterior portion of the magnetic core and separated from the core by the insulating material.

2. The magnetic inductor of claim 1, wherein the substrate comprises a layer of a printed circuit board.

3. The magnetic inductor of claim 2, wherein the substrate comprises epoxy laminate.

4. The magnetic inductor of claim 1, wherein the conductive winding further comprises conductive material deposited within a via in the insulating material.

5. The magnetic inductor of claim 1, wherein the insulating material comprises epoxy material.

6. The magnetic inductor of claim 1, wherein the magnetic core comprises ferrite material.

7. A power regulator formed using the inductor of claim 1.

8. A multi-phase power regulator formed using the inductor of claim 1.

9. A method of forming a magnetic structure, the method comprising the steps of:
providing a non-magnetic substrate;
attaching a layer of ferrite material onto the substrate;
patterning the layer of ferrite material with an etch-resistant material;
etching the ferrite material to form a magnetic core; and
depositing an insulating material over at least a portion of the magnetic core.

10. The method of claim 9, further comprising the step of forming a gap within the magnetic core.

11. The method of claim 9, wherein the patterning step comprises pattering the magnetic material to form a closed-loop shaped magnetic core.

12. A method of forming an inductor, the method comprising the steps of:
providing a non-magnetic substrate;
forming a magnetic structure on the substrate;
depositing insulating material onto the magnetic structure and the substrate;
forming vias within the insulating material and the substrate;
depositing conductive material into the vias; and
forming conductive traces coupled to the conductive material.

13. The method of claim 12, wherein the step of forming a magnetic structure further comprises the steps of providing a layer of ferrite material, patterning the layer of ferrite material with an etch-resistant material, and etching the ferrite material.

14. The method of claim 13, wherein the step of forming a magnetic structure further comprises the step of providing a sacrificial substrate.

15. A power regulator comprising:
a substrate;
a non-magnetic core formed overlying the substrate;
an insulating material formed overlying the magnetic core;
a conductive winding formed about the core, wherein the winding comprises a conductive trace formed about an exterior portion of the magnetic core and separated from the core by the insulating material; and
an integrated circuit coupled to the substrate.

16. The power regulator of claim 15, wherein the integrated circuit is coupled to the substrate using bump technology.

17. A microelectronic device comprising:
a substrate;
a plurality of magnetic structures formed overlying and in contact with the substrate;
an insulating layer formed overlying the substrate and the plurality of magnetic structures; and
a conductive winding formed about at least one of the of the plurality of magnetic structures, the winding comprising conductive traces.

18. A transformer comprising the microelectronic device of claim 17.

19. A multi-phase power regulator comprising the microelectronic device of claim 17.
